(19) United States
(12) Patent Application Publication
(10) Pub. No.: US 2014/0211105 A1
(43) Pub. Date: Jul. 31, 2014

(54) DISPLAY DEVICE AND METHOD FOR FABRICATING THE SAME

(71) Applicant: Samsung Display Co., Ltd., Yongin-City (KR)

(72) Inventor: Won Gu CHO, Cheonan-si (KR)

(21) Appl. No.: 14/136,405

(22) Filed: Dec. 20, 2013

(30) Foreign Application Priority Data
Jan. 28, 2013 (KR) 10-2013-0009350

(51) Int. Cl. G02F 1/1333

(52) U.S. Cl. CPC G02F 1/13338
USPC 349/12; 156/60

(57) ABSTRACT

Display device and method for fabricating a display device comprising a display panel displaying an image, a window positioned opposite to the display panel, and an adhesive layer interposed between the display panel and the window, wherein the adhesive layer includes a first adhesive layer formed on the window, and a second adhesive layer formed on the first adhesive layer and made of a different material from the first adhesive layer.

### CLAIM PRIORITY

This application makes reference to, incorporates the same herein, and claims all benefits accruing under 35 U.S.C. §119 from an application earlier filed in the Korean Intellectual Property Office on 28 Jan. 2013 and there duly assigned Serial No. 10-2013-0009350.

### BACKGROUND OF THE INVENTION

1. Field of the Invention

The present invention generally relates to a display device and a method for fabricating the same.

2. Description of the Prior Art

A display device is a device that visually displays data. A display panel that displays an image is included in various display devices, such as a liquid crystal display (LCD), organic light emitting diodes (OLED), and the like.

The above information disclosed in this Related Art section is only for enhancement of understanding of the background of the invention and therefore it may contain information that does not form the prior art that is already known to a person of ordinary skill in the art.

### SUMMARY OF THE INVENTION

Accordingly, one subject to be solved by the present invention is to provide a display device, which includes an adhesive layer having a first adhesive layer and a second adhesive layer formed on the first adhesive layer and made of a different material from the first adhesive layer, and has improved impact resistance and visibility of an image that is displayed on a display panel.

Another subject to be solved by the present invention is to provide a method for fabricating a display device, which can prevent an overflow of adhesives and improve flatness of an adhesive layer.

Additional advantages, subjects, and features of the invention will be set forth in part in the description which follows and in part will become apparent to those having ordinary skill in the art upon examination of the following or may be learned from practice of the invention.

In one aspect of the present invention, there is provided a display device comprising a display panel displaying an image, a window positioned opposite to the display panel, and an adhesive layer interposed between the display panel and the window, wherein the adhesive layer includes a first adhesive layer formed on the window, and a second adhesive layer formed on the first adhesive layer and made of a different material from the first adhesive layer.

In another aspect of the present invention, there is provided a display device comprising a display panel displaying an image, a window positioned opposite to the display panel, and an adhesive layer interposed between the display panel and the window, wherein the adhesive layer includes a first adhesive layer and a second adhesive layer made of a different material from the first adhesive layer, one surface of the first adhesive layer that may be opposite to the display panel may be uneven, and one surface of the second adhesive layer that may be opposite to the display panel may be flat.

In still another aspect of the present invention, there is provided a method for fabricating a display device comprising preparing a display panel or a window, having one surface on which first adhesives are spread, spreading second adhesives made of a different material from the first adhesives on the first spread adhesives, and bonding the display panel and the window to each other through the first adhesives and the second adhesives.

According to the embodiments of the present invention, at least the following effects can be achieved.

That is, since the air layers, such as bubbles, are prevented from being formed between the display panel and the adhesive layer or between the window and the adhesive layer, visibility of the image that is displayed on the display panel can be improved.

Further, since the display panel and the window are bonded to each other more stably, the overall strength of the display device is improved, and thus impact resistance of the display device can also be improved.

Further, it is possible to omit the process of cleaning the adhesives that have flowed out of the window, and the pollution can be originally prevented from occurring in the process of cleaning the adhesives that have flowed out of the window

The effects according to the present invention are not limited to the contents as exemplified above, but further various effects are included in the description.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a front view of a display device according to an embodiment of the present invention;

FIG. 2 is a plan view illustrating a window and an adhesive layer of the display device of FIG. 1;

FIG. 3 is a perspective view illustrating spreading of first adhesives on one surface of a window in a method for fabricating the display device of FIG. 1;

FIG. 4 is a front view illustrating pre-curing of first adhesives in a method for fabricating the display device of FIG. 1;

FIG. 5 is a front view illustrating spreading of second adhesives on first pre-cured adhesives in a method for fabricating the display device of FIG. 1;

FIGS. 6 to 11 are plan views exemplarily illustrating states where second adhesives are spread on first adhesives;

FIG. 12 is a front view illustrating bonding of a display panel and a window through the medium of first adhesives and second adhesives in a method for fabricating the display device of FIG. 1;

FIGS. 13 to 15 are partially enlarged cross-sectional views of one surface of adhesives after a window and the adhesives are left for a predetermined time as they stand so that one surface of second adhesives becomes flat;

FIG. 16 is a front view illustrating main-curing of first adhesives and second adhesives in a method for fabricating the display device of FIG. 1;

FIG. 17 is a front view of a display device according to another embodiment of the present invention;

FIG. 18 is a plan view illustrating a window and an adhesive layer of the display device of FIG. 17;

FIG. 19 is a perspective view illustrating spreading of first adhesives on one surface of a window in a method for fabricating the display device of FIG. 17;

FIG. 20 is a front view illustrating pre-curing of first adhesives in a method for fabricating the display device of FIG. 17;

FIG. 21 is a front view illustrating spreading of second adhesives on first pre-cured adhesives in a method for fabricating the display device of FIG. 17;

FIG. 22 is a front view illustrating bonding of a display panel and a window through the medium of first adhesives and second adhesives in a method for fabricating the display device of FIG. 17;

FIGS. 23 to 25 are partially enlarged cross-sectional views of one surface of adhesives after a window and the adhesives are left for a predetermined time as they stand so that one surface of second adhesives becomes flat; and

FIG. 26 is a front view illustrating main-curing of first adhesives and second adhesives in a method for fabricating the display device of FIG. 17.

### DETAILED DESCRIPTION OF THE EMBODIMENTS

The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims.

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described with reference to the accompanying drawings.

In order to improve visibility of an image that is displayed on a display panel and impact resistance of a display device, a window may be bonded to the display panel through the medium of an adhesive layer. In generally, in order to form such an adhesive layer, adhesives in liquid or semisolid state are heat-cured or light-cured.

Here, if the adhesives in the liquid or semisolid state are spread on the display panel or the window, the spread adhesives may flow out of the display panel or the window. In this case, it is necessary to additionally provide a process of cleaning the adhesives that have flowed out of the window, and thus a work loss may occur. Further, pollution may occur in the process of cleaning the adhesives that have flowed out of the window to cause inferior quality of the display device.

Further, an uneven portion may be formed on one surface of the adhesives in the process of spreading the adhesives or in the process of curing the adhesives, and thus air layers, such as bubbles, may be formed between the adhesives and the display panel or between the adhesives and the window. If such air layers are formed, a light path is unintentionally changed in the air layers to deteriorate visibility of an image that is displayed on the display panel. Further, the display panel and the window are unable to be bonded to each other stably, and thus impact resistance of the display device may deteriorate.

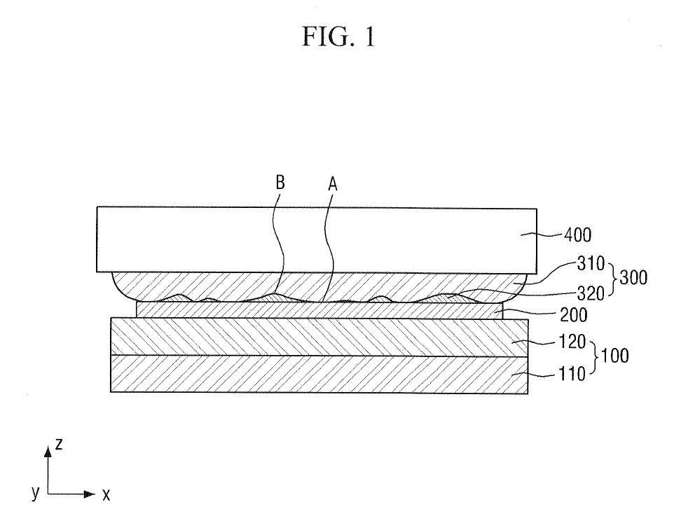

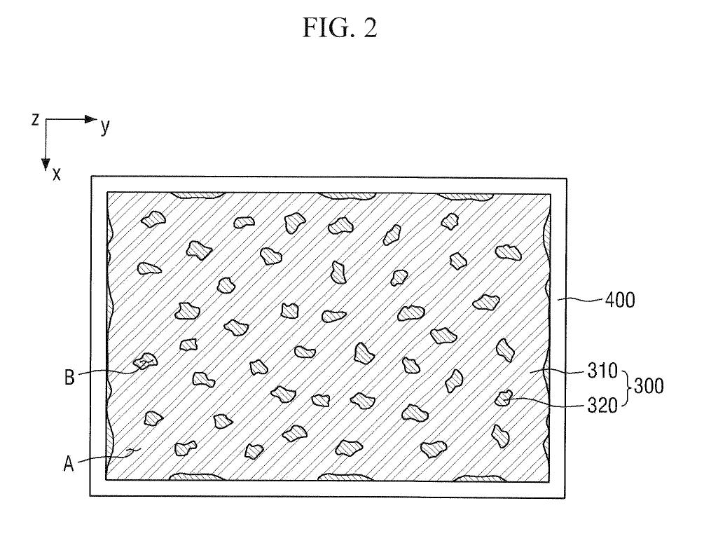

FIG. 1 is a front view of a display device according to an embodiment of the present invention, and FIG. 2 is a plan view illustrating a window 400 and an adhesive layer 300 of the display device of FIG. 1. Referring to FIGS. 1 and 2, a display device according to an embodiment of the present invention includes a display panel 100, a window 400, and an adhesive layer 300. Further, the display device according to an embodiment of the present invention may further include a polarizing film 200.

The display panel 100 may be a panel that displays an image, and may be an LCD (Liquid Crystal Display) panel, an electrophoretic display panel, an OLED (Organic Light Emitting Diode) panel, an LED (Light Emitting Diode) panel, an inorganic EL (Electro Luminescence display) panel, an FED (Field Emission Display) panel, an SED (Surface-conduction Electron-emitter display) panel, a PDP (Plasma Display Panel), or a CRT (Cathode Ray Tube) display panel. Hereinafter, as the display device according to an embodiment of the present invention, a liquid crystal display panel is exemplified, and the display panel 100 is also described as an LCD panel. However, the display device and the display panel 100 according to the present invention are not limited thereto, and various types of display devices and display panels 100 may be used.

The display panel 100 may include a first substrate 110, a second substrate 120 that may be opposite to the first substrate 110, and a liquid crystal layer (not illustrated) interposed between the first substrate 110 and the second substrate 120. The first substrate 110 may be a thin film transistor substrate that includes a plurality of thin film transistors. The second substrate 120 may be an opposite substrate that includes a color filter layer. Although not illustrated in the drawing, the display panel 100 may include a driving unit formed on the first substrate 110 to drive the display panel 100, and a flexible circuit board attached to the first substrate 110 and mounted with a driving circuit. The first substrate 110 and the second substrate 120 may be in a cuboidal shape, but are not limited thereto. The first substrate 110 and the second substrate 120 may be fabricated in various shapes depending on the shape of the display panel 100.

The window 400 may be positioned opposite to the display panel 100. In an exemplary embodiment, one surface of the display panel 100 and one surface of the window 400 that may be opposite to the display panel 100 may be in parallel to each other. In another exemplary embodiment, at least a part of the window 400 may overlap the display panel 100. In still another exemplary embodiment, the window 400 may overlap the whole of the display panel 100, and the display panel 100 may overlap a part of the window 400.

The window 400 may be made of a transparent material. In an exemplary embodiment, the window 400 may be made of glass, acrylic, polycarbonate, or a combination thereof. Further, the window 400 may be in a cuboidal shape, but is not limited thereto. The window 400 may be fabricated in various shapes depending on the shape of the display panel 100.

The window 400 may be a touch screen panel (TSP). The touch screen panel may include electrodes sensing a contact position if a contact object, for example, a hand or a touch stick, comes in contact with the touch screen panel, and a substrate supporting the electrodes. Here, both the electrodes and the board may be made of a transparent material. In an exemplary embodiment, the touch screen panel may further include a cover glass separately attached to the substrate to protect the touch screen panel.

The adhesive layer 300 may be interposed between the display panel 100 and the window 400. In an exemplary embodiment, the contact layer 300 may overlap at least a part of the window 400. In another exemplary embodiment, the adhesive layer 300 may overlap the display panel 100 and the window 400. In still another exemplary embodiment, the adhesive layer 300 may be positioned on a center portion of one surface of the window 400 that may be opposite to the display panel 100, and may come in direct contact with the one surface of the window 400.

The adhesive layer 300 may bond the display panel 100 and the window 400 to each other. That is, the adhesive layer 300 may bond the display panel 100 and the window 400 in a surface-to-surface manner by filling up a space between the display panel 100 and the window 400. As described above, since the display panel 100 and the window 400 are bonded in a surface-to-surface manner by the adhesive layer 300, the overall strength may be heightened, and thus impact resistance of the display device can be improved. Further, the adhesive layer 300 removes the air layers between the display panel 100 and the window 400, and thus visibility of the image that is displayed on the display panel 100 can be improved.

The adhesive layer 300 may be formed to have relatively higher elasticity than the display panel 100 and the window 400. That is, since the adhesive layer 300 has relatively superior elasticity and protects the display panel 100 from external impact, the mechanical stability and reliability of the display device can be improved.

The adhesive layer 300 may be made of a transparent material. In an exemplary embodiment, the adhesive layer 300 may be made of resin, optical clear adhesive (OCA), or a combination thereof. Further, the adhesive layer 300 may be made of a material having a similar refractive index to the refractive index of the window 400. Accordingly, visibility of the image that is displayed on the display panel 100 can be prevented from deteriorating due to a difference in refractive index between the adhesive layer 300 and the window 400.

The adhesive layer 300 may be formed through curing of adhesives 300a in a liquid or semisolid state. In an exemplary embodiment, the adhesive layer 300 may be formed through light-curing of the adhesives 300a in a liquid or semisolid state. That is, if the adhesives 300a including a light-curing material, such as a photo initiator, are irradiated with light, such as ultraviolet rays 700, monomer and/or oligomer, which are main components of the adhesives 300a, become polymer to cause the adhesives 300a to be cured. In another exemplary embodiment, the adhesive layer 300 may be formed through heat-curing of the adhesives 300a in a liquid or semisolid state. That is, by applying heat to the adhesives 300a including a solvent, for example, water, to remove the solvent, the adhesives 300a can be cured.

The adhesive layer 300 may include a first adhesive layer 310 and a second adhesive layer 320.

The first adhesive layer 310 may be formed on the window 400. In an exemplary embodiment, the first adhesive layer 310 may be positioned in the center portion of the one surface of the window 400 that may be opposite to the display panel 100, and may come in direct contact with the one surface of the window 400. That is, other materials may not be interposed between the first adhesive layer 310 and the window 400. Hereinafter, it is exemplified that the first adhesive layer 310 may be formed on the window 400, but is not limited thereto. The first adhesive layer 310 may be formed on the display panel 100 or the polarizing film 200.

The first adhesive layer 310 may be made of a transparent material. In an exemplary embodiment, the first adhesive layer 310 may be made of resin, optical clear adhesive (OCA), or a combination thereof. Further, the first adhesive layer 310 may be made of a material having a similar refractive index to the refractive index of the window 400. Further, the first adhesive layer 310 may be formed through curing of the first adhesives 310a in a liquid or semisolid state.

One surface of the first adhesive layer 310 that may be opposite to the display panel 100 may be uneven. In an exemplary embodiment, the uneven portion of one surface of the first adhesive layer 310 may have a random shape, but is not limited thereto. The uneven portion may have a constant shape.

One surface of the first adhesive layer 310 that may be opposite to the display panel 100 may include at least one convex portion A and at least one concave portion B. Here, the convex portion A may mean a portion where one surface of the first adhesive layer 310 that may be opposite to the display panel 100 projects in the direction of the display panel 100, and the concave portion B may mean a portion where one surface of the first adhesive layer 310 that may be opposite to the display panel 100 projects in the direction of the window 400. Further, the convex portion A may mean a portion where the thickness of the first adhesive layer 310 that may be positioned on the window 400 may be thick, and the concave portion B may mean a portion where the thickness of the first adhesive layer 310 that may be positioned on the window 400 may be thin. Further, the convex portion A may mean a portion where the first adhesive layer 310 comes in direct contact with the polarizing film 200 or the display panel 100, and the concave portion B may mean a portion where the second adhesive layer 320 comes in direct contact with the polarizing film 200 or the display panel 100. Further, the convex portion A may mean a region where the first adhesive layer 310 may be exposed on one surface of the adhesive layer 300 that may be opposite to the display panel 100, and the concave portion B may mean a region where the second adhesive layer 320 may be exposed on one surface of the adhesive layer 300 that may be opposite to the display panel 100.

The convex portion A and the concave portion B may have random shapes. In an exemplary embodiment, the concave portion B may be in an island shape, and the convex portion A may be in a net shape, but are not limited thereto. The convex portion A and the concave portion B may be in various shapes depending on methods for forming the first adhesive layer 310. Further, a plurality of convex portions A and concave portions B may be provided, and the plurality of concave portions B may be surrounded by the plurality of convex portions A. Further, the plurality of convex portions A and concave portions B may be randomly distributed.

The second adhesive layer 320 may be formed on the first adhesive layer 310. In an exemplary embodiment, the second adhesive layer 320 may overlap at least a part of the first adhesive layer 310, and may come in direct contact with the first adhesive layer 310. That is, other materials may not be interposed between the second adhesive layer 320 and the first adhesive layer 310.

The second adhesive layer 320 may be positioned on the concave portion B of one surface of the first adhesive layer 310 that may be opposite to the display panel 100. That is, the second adhesive layer 320 may fill up the concave portion B. In other words, the second adhesive layer 320 may be surrounded by the convex portion A of one surface of the first adhesive layer 310 that may be opposite to the display panel 100. Here, the second adhesive layer 320 may be positioned on not only a portion that may be completely surrounded by the convex portion A but also a portion that may be partially surrounded by the convex portion A.

Since the second adhesive layer 320 fills up the concave portion B of one surface of the first adhesive layer 310 that may be opposite to the display panel 100, the shape of the second adhesive layer 320 may correspond to the shape of the concave portion B on which the second adhesive layer 320 may be positioned. In an exemplary embodiment, if the concave portion B may be in an island shape, the second adhesive layer 320 may also be in an island shape, while if the concave portion B may be in a net shape, the second adhesive layer 320 may also be in a net shape. However, the present invention is not limited thereto, and the second adhesive layer 320 may be in various shapes depending on the shape of the concave portion B. In an exemplary embodiment illustrated in FIG. 2, the second adhesive layer 320 may include a plurality of island patterns that are spaced apart from each other. Here, the respective island patterns may be in a random shape, or may be randomly distributed.

The second adhesive layer 320 may be made of a different material from the first adhesive layer 310. In an exemplary embodiment, the second adhesive layer 320 may be made of resin, optical clear adhesive (OCA), or a combination thereof, which has a different composition from the first adhesive layer 310. Further, the second adhesive layer 320 may be made of a material which has a similar refractive index to the window 400, but has a different refractive index from the first adhesive layer 310. Further, the second adhesive layer 320 may be formed through curing of the second adhesives 320a which may be in a liquid or semisolid state, and has a different composition from the first adhesives 310a.

The viscosity of the second adhesive layer 320 may be lower than the viscosity of the first adhesive layer 310. In an exemplary embodiment, the viscosity of the second adhesive layer 320 may be about 0.5 to 0.7 times the viscosity of the first adhesive layer 310. Further, the second adhesive layer 320 may be formed through curing of the second adhesives 320a having the viscosity that may be equal to or lower than 500 cP, and the first adhesive layer 310 may be formed through curing of the first adhesives 310a having the viscosity that exceeds 500 cP. In an exemplary embodiment, the viscosity of the second adhesives 320a before curing may be 0 to 500 cP, and preferably, 100 to 300 cP, and the viscosity of the first adhesives 310a before curing may be 2000 to 20000 cP, and preferably, 8000 to 12000 cP.

In the display device, the volume occupied by the second adhesive layer 320 may be 1/100 to 1/1000 of the volume occupied by the first adhesive layer 310. That is, the second adhesive layer 320 may fill up the concave portion B of one surface of the first adhesive layer 310 that may be opposite to the display panel 100, and the volume of the second adhesive layer 320 may be greatly smaller than the volume of the first adhesive layer 310.

One surface of the second adhesive layer 320 that may be opposite to the display panel 100 may be flat. In an exemplary embodiment, one surface of the second adhesive layer 320 that may be opposite to the display panel 100 may be in parallel to one surface of the window 400 and/or one surface of the display panel 100. Although one surface of the first adhesive layer 310 that may be opposite to the display panel 100 may be uneven, that is, although one surface of the first adhesive layer 310 includes the concave portion B and the convex portion A, the second adhesive layer 320 fills up the concave portion B of one surface of the first adhesive layer 310 that may be opposite to the display panel 100, and one surface of the second adhesive layer 320 that may be opposite to the display panel 100 may be made to be flat. Accordingly, planarization of one surface of the adhesive layer 300 that may be opposite to the display panel 100 can be performed. As described above, through planarization of one surface of the adhesive layer 300 that may be in contact with the display panel 100, air layers, such as bubbles, are prevented from being formed between the display panel 100 and the adhesive layer 300, and thus visibility of an image that may be displayed on the display panel 100 can be improved. Further, by bonding the display panel 100 and the window 400 to each other more stably, the overall strength of the display device can be improved, and thus impact resistance of the display device can also be improved.

The polarizing film 200 may be interposed between the display panel 100 and the adhesive layer 300. The polarizing film 200 can dividedly pass or intercept vertically or horizontally polarized waves of light incident to the polarizing film 200.

One surface of the polarizing film 200 may come in contact with the adhesive layer 300, and the other surface of the polarizing film 200 that may be opposite to one surface of the polarizing film 200 may be in contact with the display panel 100. Here, the polarizing film 200 may come in contact with both the first adhesive layer 310 and the second adhesive layer 320. A portion where the polarizing film 200 and the first contact layer 310 come in contact with each other may be the convex portion A, and a portion where the polarizing film 200 and the second adhesive layer 320 may be the concave portion B.

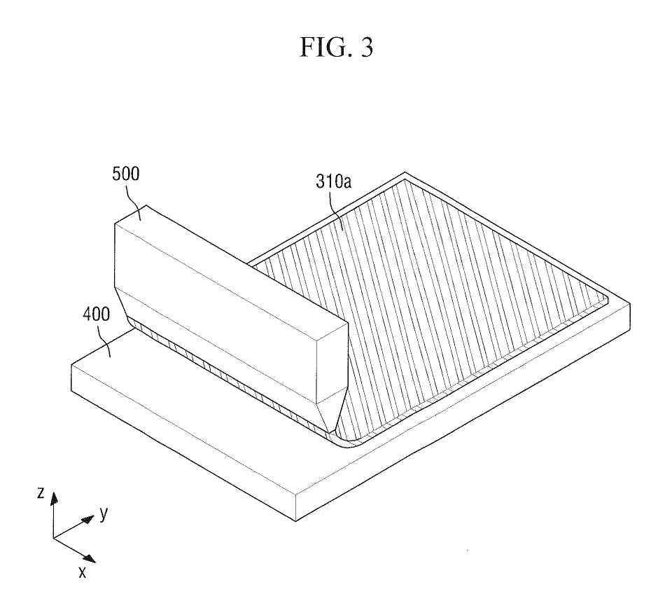

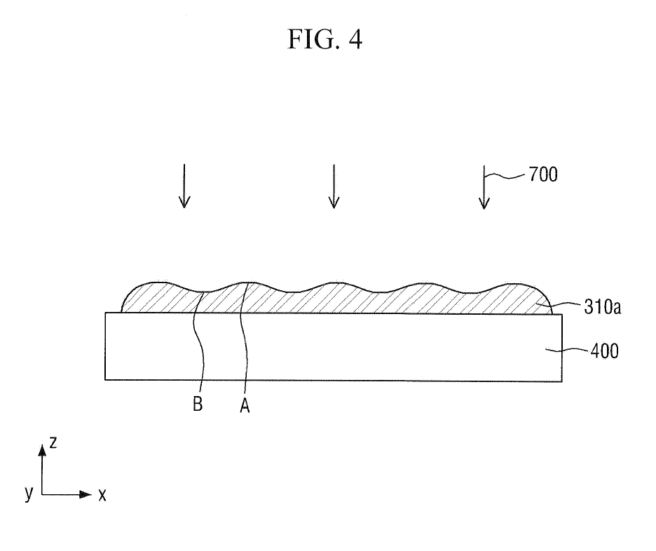

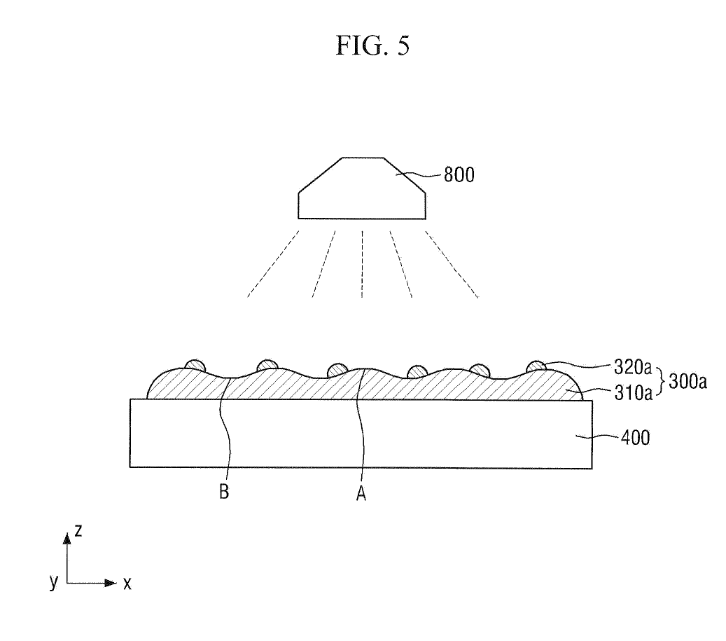

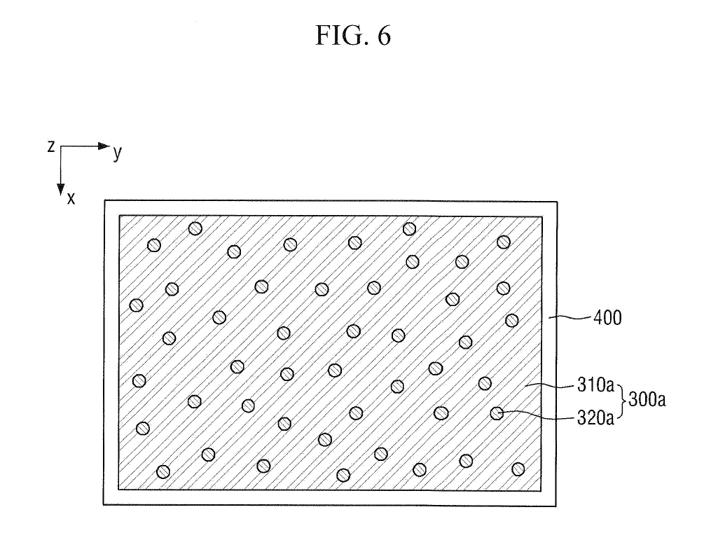

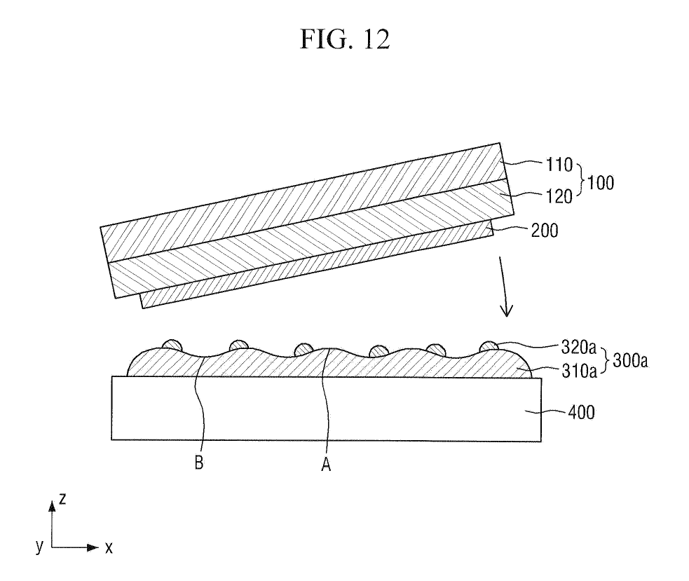

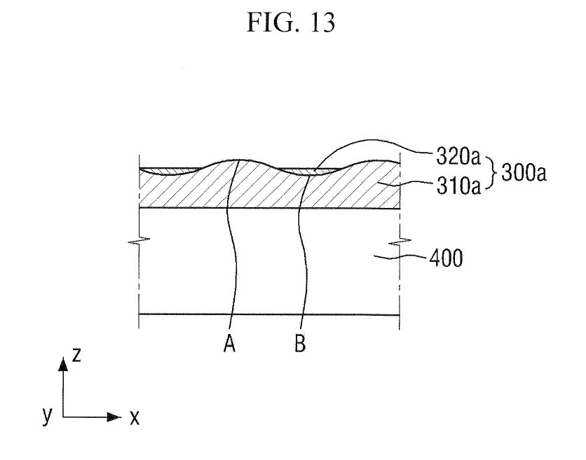

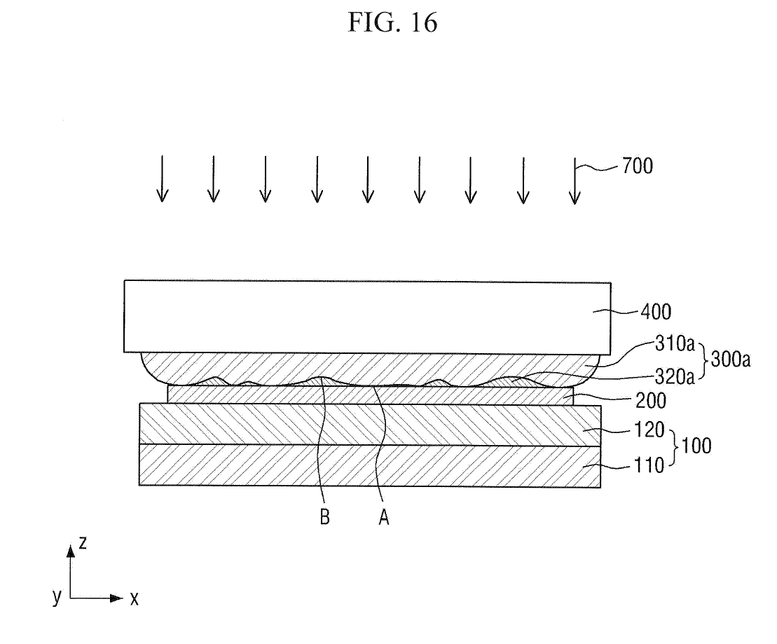

FIGS. 3 to 16 are schematic views illustrating a method for fabricating a display device according to an embodiment of the present invention. That is, FIG. 3 is a perspective view illustrating spreading of first adhesives 310a on one surface of a window 400 in a method for fabricating the display device of FIG. 1. FIG. 4 is a front view illustrating pre-curing of first adhesives 310a in a method for fabricating the display device of FIG. 1. FIG. 5 is a front view illustrating spreading of second adhesives 320a on first pre-cured adhesives 310a in a method for fabricating the display device of FIG. 1. FIGS. 6 to 11 are plan views exemplarily illustrating states where second adhesives 320a are spread on first adhesives 310a. FIG. 12 is a front view illustrating bonding of a display panel 100 and a window 400 through the medium of first adhesives 310a and second adhesives 320a in a method for fabricating the display device of FIG. 1. FIGS. 13 to 15 are partially enlarged cross-sectional views of one surface of adhesives 300a after a window 400 and the adhesives 300a are left for a predetermined time as they stand so that one surface of second adhesives 320a becomes flat. FIG. 16 is a front view illustrating main-curing of first adhesives 310a and second adhesives 320a in a method for fabricating the display device of FIG. 1. For convenience in explanation, the same reference numerals are used for elements substantially the same as the elements illustrated in the drawings of FIGS. 1 and 2, and duplicate explanation thereof will be omitted.

Referring to FIG. 3, the first adhesives 310a may be first spread on one surface of the window 400. Hereinafter, it is exemplified that the first adhesives 310a are spread on one surface of the window 400, but are not limited thereto. The first adhesives 310a may be spread on one surface of the display panel 100 or the polarizing film 200. Here, the spreading means of the first adhesives 310a may be a slit coater 500, but is not limited thereto. The slit coater 500 may be formed to extend as long as the length that corresponds to the length of one side of the window 400, and may be arranged in parallel to the one side of the window 400. The slit coater 500 may move in parallel to the one surface of the window 400 in the direction that may be perpendicular to the one side of the window 400, and may discharge the first adhesives 310a on the one surface of the window 400.

Referring to FIG. 4, after the first adhesives 310a are spread on the one surface of the window 400, the first adhesives 310a may be directly pre-cured. Here, the pre-curing may be light-curing using ultraviolet rays 700, and the first adhesives 310a may be irradiated with the ultraviolet rays 700 only to the extent that the first adhesives 310a are prevented from flowing so that the first adhesives 310a do not flow out of the window 400. That is, by adjusting an irradiation amount or wavelength of the ultraviolet rays 700, the first adhesives 310a can be fixed to the one surface of the window 400. As described above, if the first adhesives 310a are pre-cured just after the first adhesives 310a are spread on the one surface of the window 400, the first adhesives 310a can be prevented from flowing out of the window 400. Accordingly, it is possible to omit the process of cleaning the adhesives 300a that have flowed out of the window 400, and thus the pollution can be originally prevented from occurring in the process of cleaning the adhesives 300a that have flowed out of the window 400.

In the process of spreading the first adhesives 310a as shown in FIG. 3, or in the process of pre-curing the first adhesives 310a as shown in FIG. 4, an uneven portion that includes a convex portion A and a concave portion B may be formed on the surface of the first adhesives 310a, that is, on the upper surface thereof. For example, in the process of spreading the first adhesives 310a, bubbles may be trapped between the first adhesives 310a and the window 400, and the trapped bubbles may get away to an outside to form the uneven portion. Further, the uneven portion may be formed on the surface of the first adhesives 310a due to a difference between moving speeds of a slit coater 500 or the difference in size between discharge holes of the first adhesives 310a formed on the slit coater 500. As another example, the uneven portion may be formed on the surface of the first adhesives 310a due to a partial difference between volume contractions of the first adhesives 310a in the pre-curing process of the first adhesives 310a.

Referring to FIG. 5, second adhesives 320a may be spread on the first adhesives 310a spread and pre-cured. Here, the second adhesives 320a may be made of a different material from the first adhesives 310a. In an exemplary embodiment, the viscosity of the second adhesives 320a may be lower than the viscosity of the first adhesives 310a spread in the process of spreading the first adhesives 310a as shown in FIG. 3. In another exemplary embodiment, the viscosity of the second adhesives 320a may be equal to or lower than 500 cP, and preferably 100 to 300 cP. Further, the spreading amount of the second adhesives 320a may be 1/100 to 1/1000 of the spreading amount of the first adhesives 310a.

The second adhesives 320a may be sprayed on the first adhesives 310a using a spray 800. If the second adhesives 320a are sprayed, the second adhesives 320a may form a plurality of drops on the first adhesives 310a. Further, the second adhesives 320a may be dispensed on the first adhesives 310a using a dispenser. In addition, various means and methods for spreading the second adhesives 320a may be used.

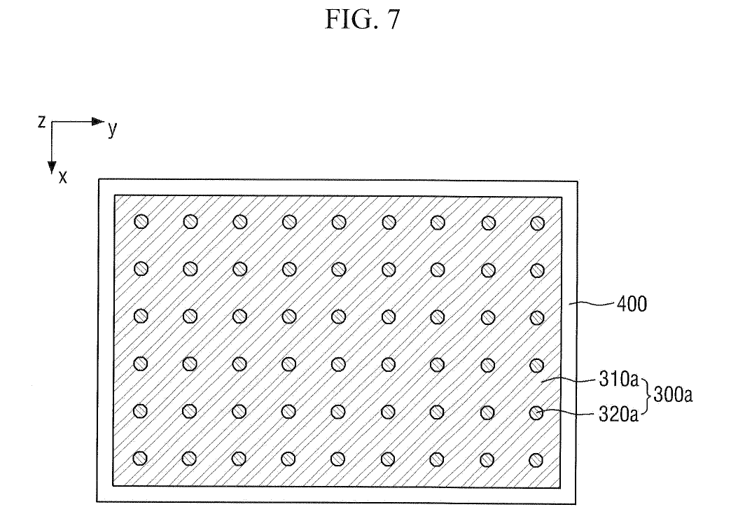

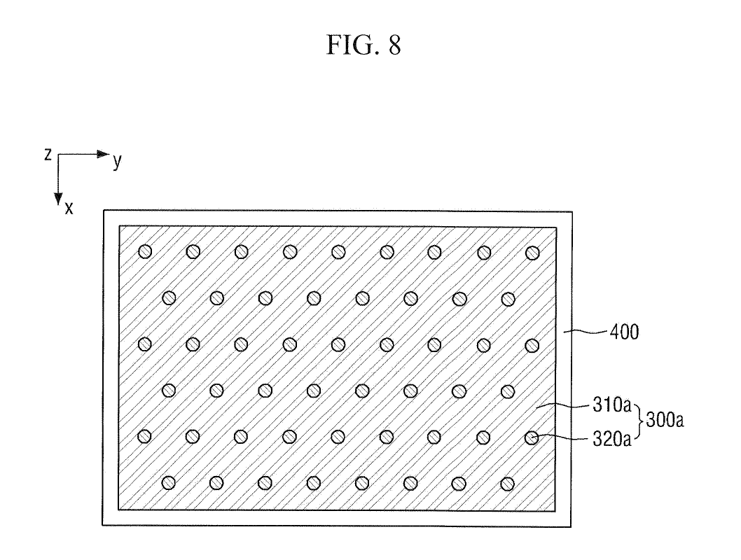

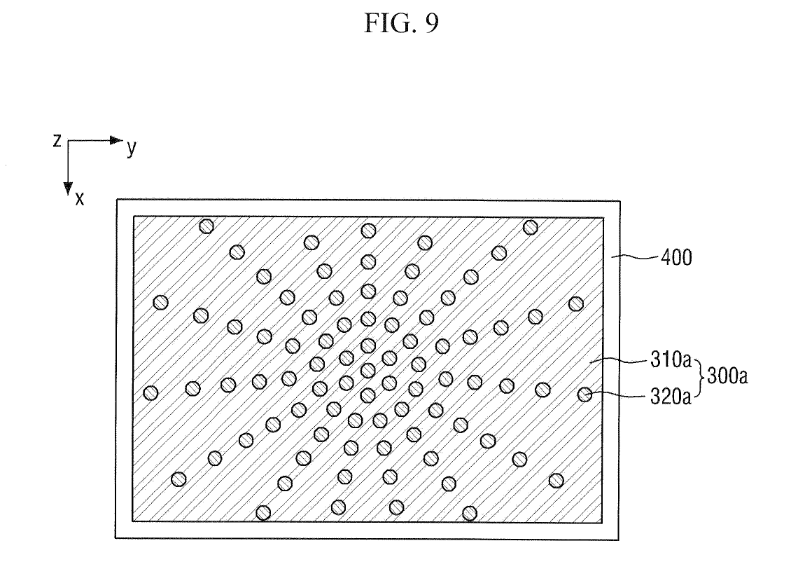

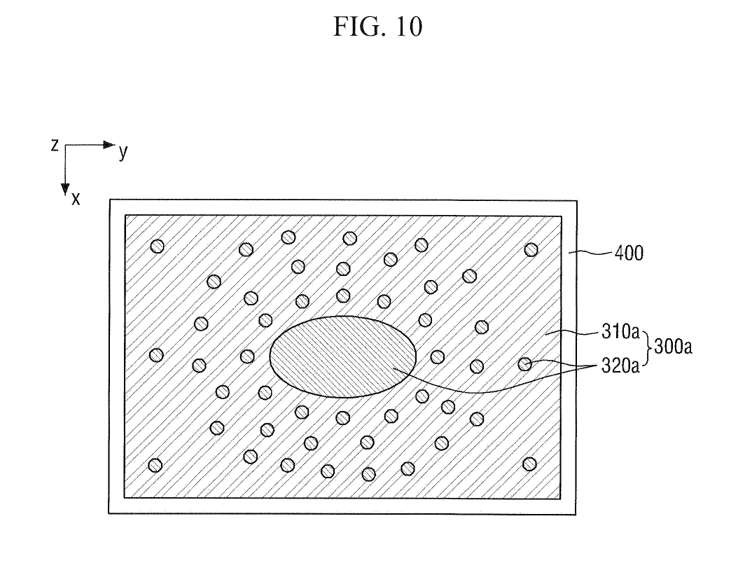

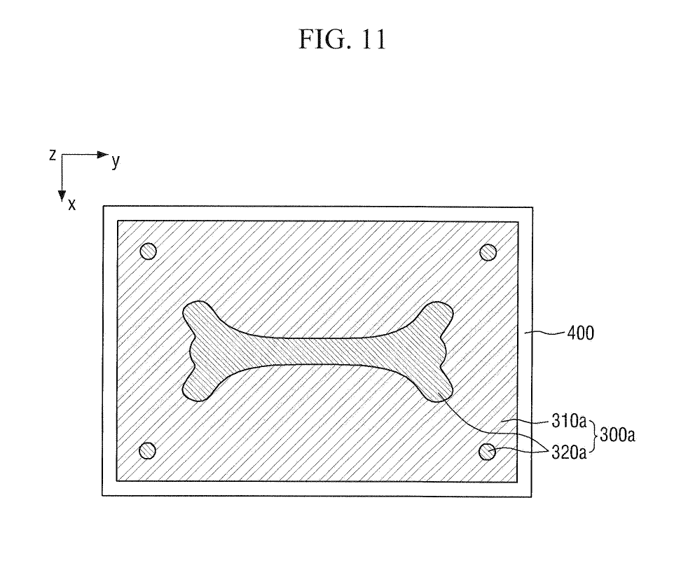

FIGS. 6 to 11 are plan views exemplarily illustrating states where second adhesives 320a are spread on first adhesives 310a. First, referring to FIG. 6, a plurality of drops of the second adhesives 320a may be randomly arranged on the first adhesives 310a. Next, referring to FIGS. 7 and 8, the plurality of drops of the second adhesives 320a may be arranged on the first adhesives 310a in the form of a matrix. Next, referring to FIG. 9, the plurality of drops of the second adhesives 320a may be arranged to be diffused from the center portion to outer portions of the first adhesives 310a. Next, referring to FIG. 10, the second adhesives 320a may be concentrically spread in the center portion of the first adhesives 310a to form a relative large drop, and a plurality of small drops may be arranged to be diffused from the large drop to the outer portions of the first adhesives 310a. Next, referring to FIG. 11, the second adhesives 320a may be spread on the first adhesives 310a through expecting of the spreading root of the second adhesives 320a. FIG. 11 illustrates that drops of the second adhesives 320a are formed on four corners of the first adhesives 310a, and the second adhesives 320a are spread in the center portion of the first adhesives 310a schematically in “H” shape. However, the present invention is not limited thereto.

Referring to FIG. 12, after the second adhesives 320a are spread, the display panel 100 and the window 400 may be bonded to each other through the first adhesives 310a and the second adhesives 320a. In an exemplary embodiment, by making the corner portions of the adhesives 300a, that is, the first adhesives 310a and the second adhesives 320a, and the corresponding corner portions of the display panel 100 come in contact with each other and making the adhesives 300a sequentially come in contact with the portions adjacent to the corner portions of the display panel 100, air layers, such as bubbles, can be prevented from being formed between the display panel 100 and the adhesives 300a. Further, the second adhesives 320a, which are gathered due to the drop phenomenon or the like in the bonding process, are spread and fill up the concave portion B, and thus the surface of the adhesives 300a can be flat.

Here, the bonding process may not be performed just after the second adhesives 320a are spread, but may be performed after being left for a predetermined time. That is, since the viscosity of the second adhesives 320a may be relatively low, the window 400 and the adhesives 300a may be left until the second adhesives 320a are naturally spread at normal temperature and normal pressure and one surface of the second adhesives 320a becomes flat. That is, the bonding process may be performed after the one surface of the second adhesives 320a has become flat. As described above, by performing the bonding process after the one surface of the second adhesives 320a becomes flat, the flatness of the one surface of the adhesives 300a can be improved.

FIGS. 13 to 15 are partially enlarged cross-sectional views of one surface of adhesives 300a after a window 400 and the adhesives 300a are left for a predetermined time as they stand so that one surface of the second adhesives 320a becomes flat.

First, referring to FIG. 13, the second adhesives 320a are naturally spread on the first adhesives 310a to fill up a part of the concave portion B. That is, by filling up only a part of the concave portion B rather than the whole of the concave portion B, one surface of the adhesives 300a may not be completely flat. This is because the amount of the second adhesives 320a is not sufficient at least partly, or the thickness of the first adhesives 310a may be thick at least partly.

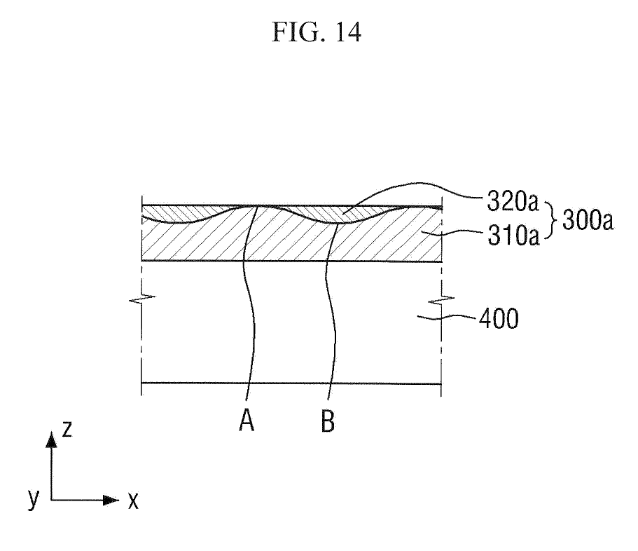

Next, referring to FIG. 14, the second adhesives 320a are naturally spread on the first adhesives 310a to fill up the whole of the concave portion B. That is, by filling up the whole of the concave portion B, one surface of the adhesives 300a can be completely flat. This is because the spreading amount of the second adhesives 320a corresponds to the number and the shape of the concave portions B.

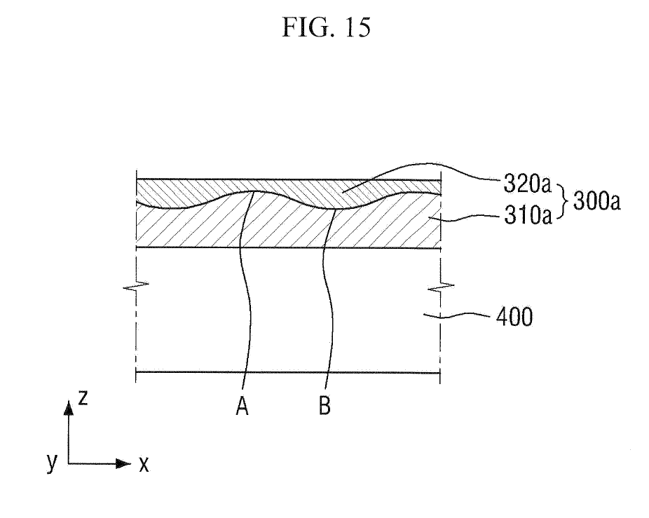

Next, referring to FIG. 15, the second adhesives 320a can completely cover the first adhesives 310a. That is, the second adhesives 320a may be positioned not only on the concave portion B but also on the convex portion A. This is because the amount of the second adhesives 320a is too large at least partly, or the thickness of the first adhesives 310a may be thin at least partly. Even in the case as illustrated in FIG. 15, one surface of the adhesives 300a becomes completely flat, but the second adhesives 320a having low viscosity may flow out of the window 400.

Since FIGS. 13 to 15 are partially enlarged cross-sectional view of one surface of the adhesives 300a, the surface states may coexist in a process of fabricating a display device. That is, after the window 400 and the adhesives 300a are left for a predetermined time so that the one surface of the second adhesives 320a becomes flat, it can be observed that the one surface of the adhesives 300a is in any one of the states illustrated in FIGS. 13 to 15. It is preferable that the second adhesives 320a fills up the whole of the concave portion B as shown in FIG. 14. However, the states illustrated in FIGS. 13 and 15 may be changed to the state illustrated in FIG. 14 in a compressing process to be described later.

After the display panel 100 and the adhesives 300a stably come in contact with each other, the adhesives 300a can be compressed by applying pressure in the direction from the upper portion of the display panel 100 to the adhesives 300a and/or in the direction from the lower portion of the window 400 to the adhesives 300a. By compressing the adhesives 300a as described above, both surfaces of the adhesives 300a becomes flat, and thus the visibility of the image that is displayed on the display panel 100 can be improved. Further, as the drop-type second adhesives 320a are spread to fill up the concave portion B, one surface of the adhesives 300a, on which the second adhesives 320a are positioned, becomes flat.

Referring to FIG. 16, after bonding the display panel 100 and the window 400 through the first adhesives 310a and the second adhesives 320, the first adhesives 310a and the second adhesives 320a can be main-cured. Here, the main-curing may be light-curing, and the first adhesives 310a and the second adhesives 320a may be irradiated with the ultraviolet rays 700 to the extent that the first adhesives 310a and the second adhesives 320a are completely cured. Since the window 400 can be made of a transparent material, the ultraviolet rays 700 may be emitted from the upper portion of the window 400 to the adhesives 300a through the window 400. Further, the ultraviolet rays 700 may be directly emitted from a side portion of the adhesives 300a to the adhesives 300a. By adjusting the irradiation amount or the wavelength of the ultraviolet rays 700, the adhesives 300a between the display panel 100 and the window 400 can be completely cured. As described above, if the adhesives 300a are main-cured after the display panel 100 and the window 400 are first bonded, the display panel 100 and the window 400 are bonded to each other more stably, and thus impact resistance of the display device can be improved.

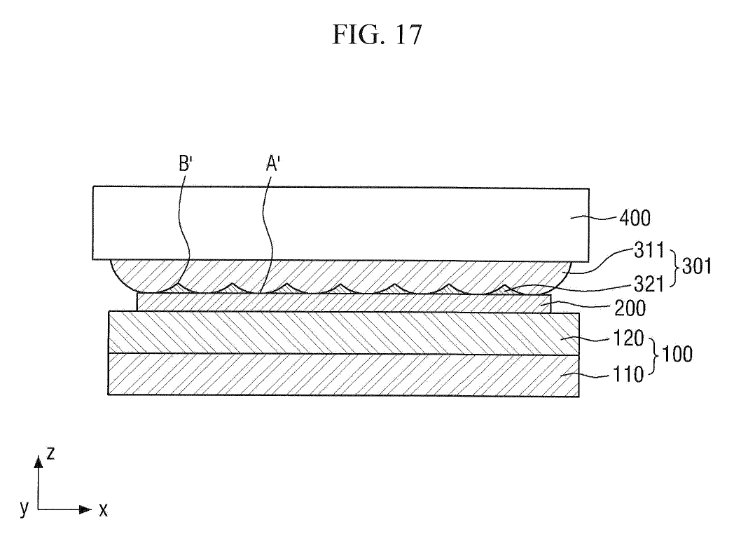

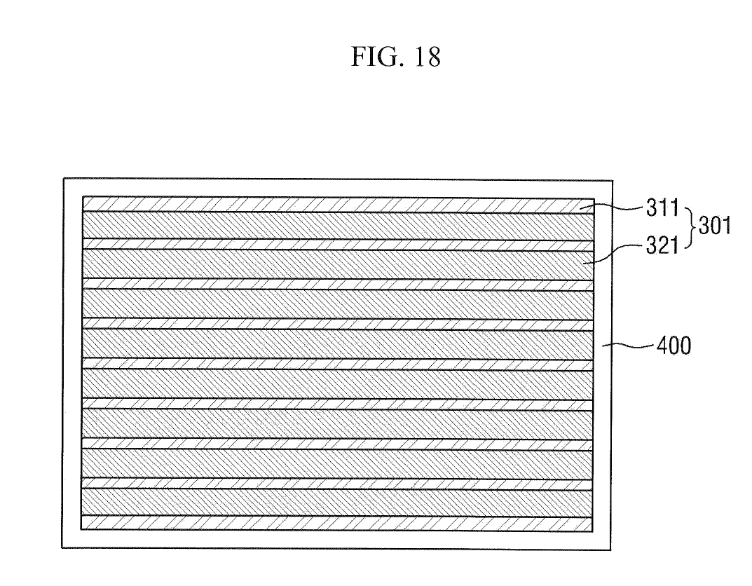

FIG. 17 is a front view of a display device according to another embodiment of the present invention, and FIG. 18 is a plan view illustrating a window 400 and an adhesive layer 301 of the display device of FIG. 17. For convenience in explanation, the same reference numerals are used for elements substantially the same as the elements illustrated in the drawings of FIGS. 1 and 2, and duplicate explanation thereof will be omitted.

One surface of the first adhesive layer 311 of the display device according to another embodiment of the present invention may include a convex portion A′ and a concave portion B′. Here, the convex portion A′ and the concave portion B′ may be in a line pattern. In an exemplary embodiment, both the pattern of the concave portion B′ and the pattern of the convex portion A′ may be line patterns, but are not limited thereto. Further, a plurality of convex portions A′ and concave portions B′ may be provided and arranged alternately.

The second adhesive layer 321 of the display device according to another embodiment of the present invention may include at least one line pattern. Here, the line pattern may be formed to extend from one end portion of the first adhesive layer 311 to the other end portion of the first adhesive layer 311 that may be opposite to the one end portion. Further, a plurality of line patterns may be provided. The plurality of line patterns may have the same shape, and may be spaced apart from each other for a predetermined distance. Further, the plurality of line patterns may be distributed side by side in parallel to each other.

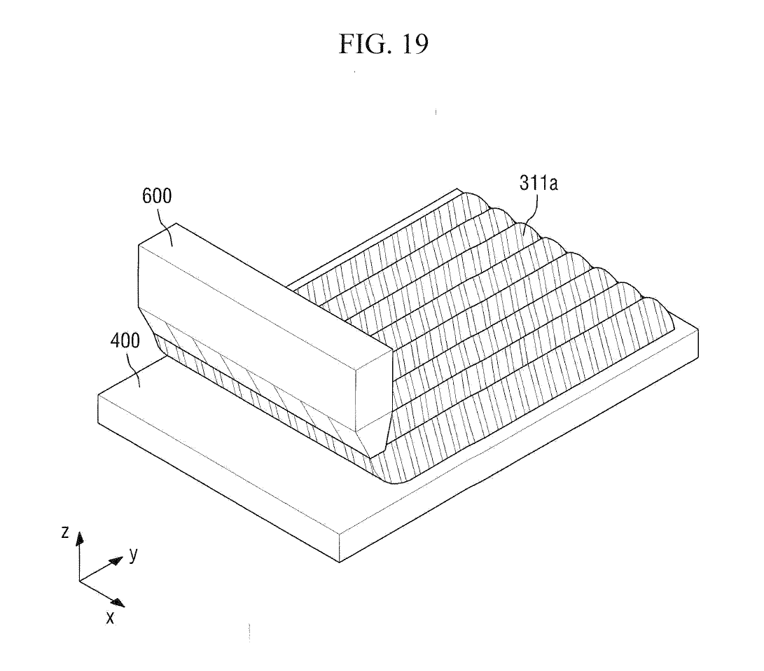

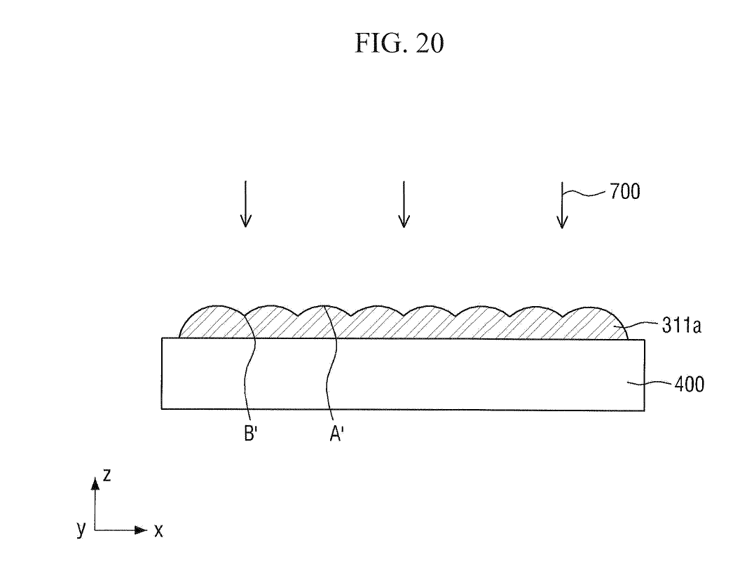

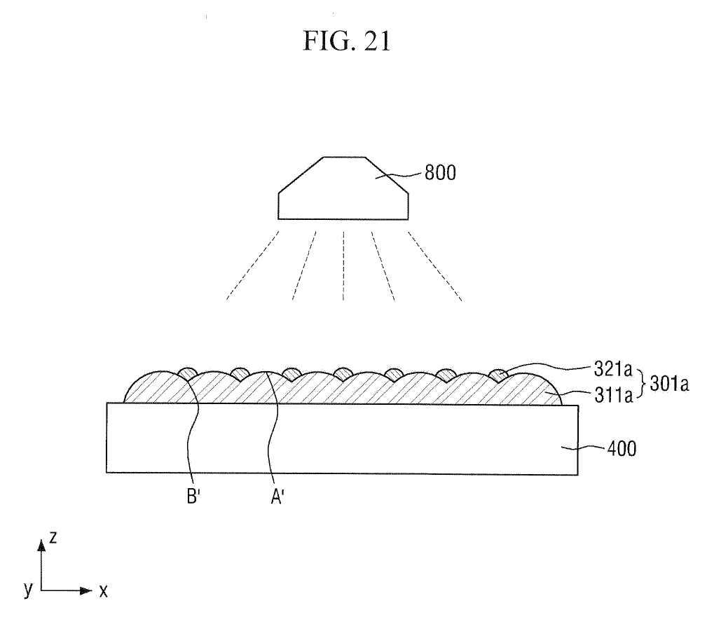

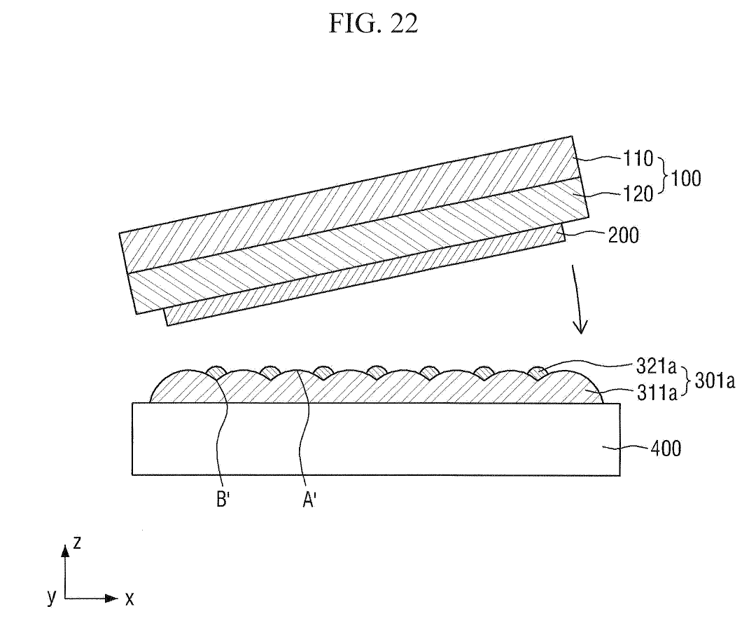

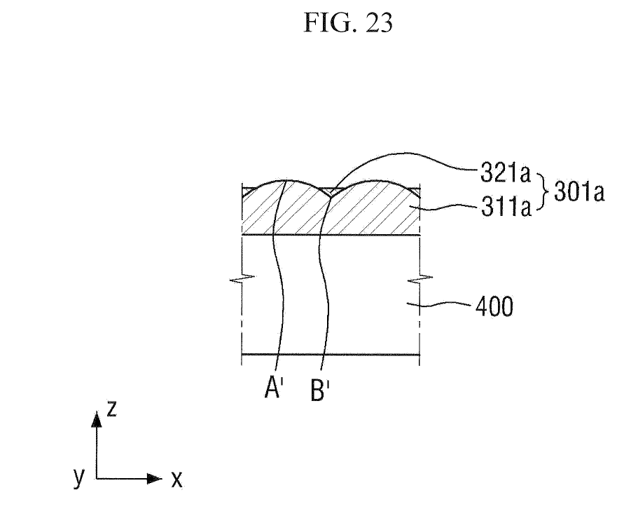

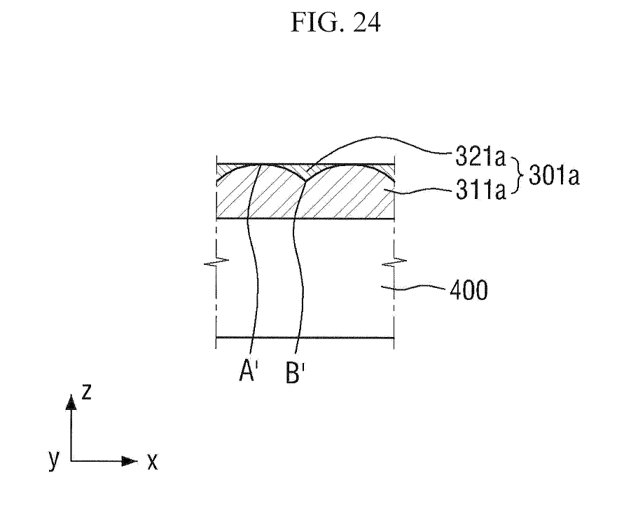

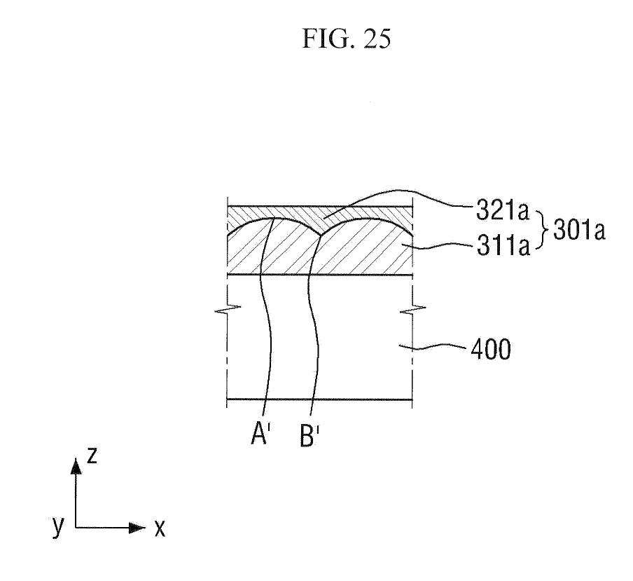

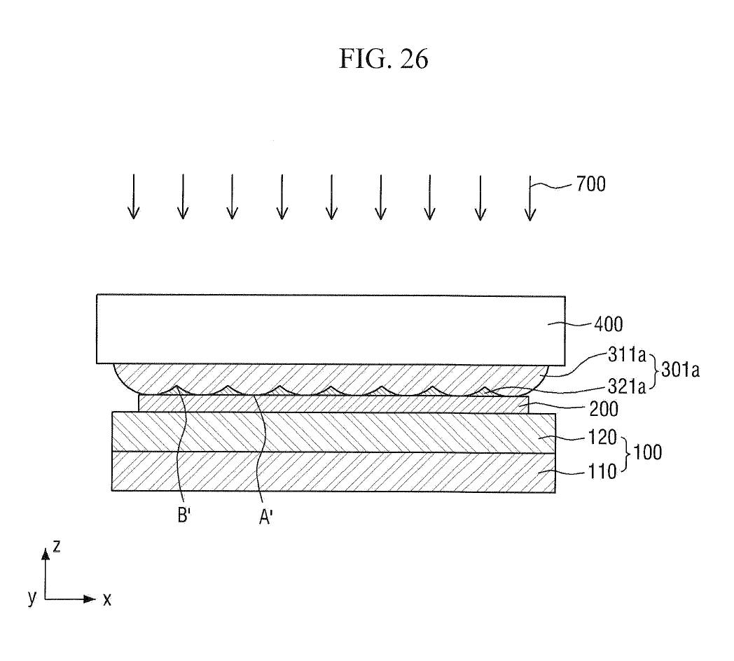

FIGS. 19 to 26 are schematic views illustrating a method for fabricating the display device of FIG. 17. That is, FIG. 19 is a perspective view illustrating spreading of first adhesives 311a on one surface of a window 400 in a method for fabricating the display device of FIG. 17. FIG. 20 is a front view illustrating pre-curing of first adhesives 311a in a method for fabricating the display device of FIG. 17, and FIG. 21 is a front view illustrating spreading of second adhesives 321a on first pre-cured adhesives 311a in a method for fabricating the display device of FIG. 17. FIG. 22 is a front view illustrating bonding of a display panel 100 and a window 400 through the medium of first adhesives 311a and second adhesives 321a in a method for fabricating the display device of FIG. 17. FIGS. 23 to 25 are partially enlarged cross-sectional views of one surface of adhesives 301a after a window 400 and the adhesives 301a are left for a predetermined time as they stand so that one surface of second adhesives 321a becomes flat. FIG. 26 is a front view illustrating main-curing of first adhesives 311a and second adhesives 321a in a method for fabricating the display device of FIG. 17. For convenience in explanation, the same reference numerals are used for elements substantially the same as the elements illustrated in the drawings of FIGS. 3 to 16, and duplicate explanation thereof will be omitted.

Referring to FIG. 19, a means for spreading first adhesives 311a on one surface of a window 400 may be a multi-nozzle 600, but is not limited thereto. The multi-nozzle 600 may include a plurality of nozzles, and the plurality of nozzles may be arranged side by side in parallel to one side of the window 400. The plurality of nozzles may discharge the first adhesives 311a on the one surface of the window 400 while moving in parallel to the one surface of the window 400 in the direction perpendicular to the one side of the window 400.

As described above, if the first adhesives 311a are discharged using the multi-nozzle 600, the shape of the first adhesives 311a on the window 400 may become regular. In an exemplary embodiment, the surface of the first adhesives 311a, that is, the upper surface thereof may include an uneven portion, and the convex portion A′ and the concave portion B′ may be in a line pattern, and may be alternately arranged.

Referring to FIG. 20, the first adhesives 311a may be pre-cured just after the first adhesives 311a are discharged. This process may be substantially the same of the process of FIG. 4.

Referring to FIG. 21, the first adhesives 311a and the second adhesives 321a may be spread after the first adhesives 311a are pre-cured. This process may be substantially the same as the process of FIG. 5. Further, examples of the method for spreading the second adhesives 321a are as illustrated in FIGS. 6 to 11.

Referring to FIG. 22, after the second adhesives 321a are spread, the display panel 100 and the window 400 may be bonded to each other through the first adhesives 311a and the second adhesives 321a. This process may be substantially the same as the process of FIG. 12. Further, the bonding process may not be performed just after the second adhesives 321a are spread, but may be performed after being left for a predetermined time. FIGS. 23 to 25 are partially enlarged cross-sectional views of one surface of the adhesives 301a after the window 400 and the adhesives 301a are left for the predetermined time as they stand so that the one surface of the second adhesives 321a becomes flat. Since FIGS. 23 to 25 correspond to FIGS. 13 to 15, respectively, the detailed explanation thereof will be omitted.

Referring to FIG. 26, the first adhesives 311a and the second adhesives 321a can be main-cured after the display panel 100 and the window 400 are bonded to each other through the first adhesives 311a and the second adhesives 321a. This process may be substantially the same as the process of FIG. 16.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A display device, comprising:
a display panel displaying an image;
a window positioned opposite to the display panel; and
an adhesive layer interposed between the display panel and the window,
wherein the adhesive layer includes a first adhesive layer formed on the window, and a second adhesive layer formed on the first adhesive layer and made of a different material from the first adhesive layer.

2. The display device of claim 1, wherein viscosity of the second adhesive layer is lower than viscosity of the first adhesive layer.

3. The display device of claim 2, wherein the second adhesive layer is formed from a composition having viscosity that is equal to or lower than 500 cP.

4. The display device of claim 1, wherein one surface of the first adhesive layer that is opposite to the display panel is uneven, and
one surface of the second adhesive layer that is opposite to the display panel is flat.

5. The display device of claim 4, wherein the one surface of the first adhesive layer comprises a convex portion and a concave portion, and
the second adhesive layer fills up the concave portion.

6. The display device of claim 5, wherein the second adhesive layer is surrounded by the convex portion.

7. The display device of claim 1, wherein the second adhesive layer comprises a plurality of island patterns that are spaced apart from each other, and
the patterns have random shapes.

8. The display device of claim 7, wherein the patterns are randomly distributed.

9. The display device of claim 1, wherein the second adhesive layer comprises at least one line pattern.

10. The display device of claim 9, wherein a plurality of patterns are provided, and
the plurality of patterns are distributed side by side in parallel to each other.

11. The display device of claim 1, wherein the window is a touch screen panel.

12. The display device of claim 1, further comprising a polarizing film interposed between the display panel and the adhesive layer.

13. The display device of claim 12, wherein one surface of the first adhesive layer that is opposite to the display panel comprises a convex portion and a concave portion, and
the convex portion comes in contact with the display panel or the polarizing film.

14. A display device, comprising:
a display panel displaying an image;
a window positioned opposite to the display panel; and
an adhesive layer interposed between the display panel and the window,
wherein the adhesive layer includes a first adhesive layer and a second adhesive layer made of a different material from the first adhesive layer,
one surface of the first adhesive layer that is opposite to the display panel is uneven, and
one surface of the second adhesive layer that is opposite to the display panel is flat.

15. The display device of claim 14, wherein the one surface of the first adhesive layer comprises a convex portion and a concave portion, and
the second adhesive layer fills up the concave portion.

16. The display device of claim 14, wherein viscosity of the second adhesive layer is lower than viscosity of the first adhesive layer.

17. The display device of claim 14, wherein the second adhesive layer comprises a plurality of island patterns that are spaced apart from each other, and
the patterns have random shapes.

18. The display device of claim 14, wherein the second adhesive layer comprises at least one line pattern.

19. A method for fabricating a display device, comprising:
preparing a display panel or a window, having one surface on which first adhesives are spread;
spreading second adhesives made of a different material from the first adhesives on the first spread adhesives; and
bonding the display panel and the window to each other through the first adhesives and the second adhesives.

20. The method for fabricating a display device of claim 19, wherein viscosity of the second adhesives is lower than viscosity of the first adhesives.

21. The method for fabricating a display device of claim 19, wherein the preparing the display panel or the window comprises:
spreading the first adhesives on one surface of the display panel or the window; and
pre-curing the first adhesives.

22. The method for fabricating a display device of claim 19, wherein the spreading the second adhesives spreads or dispenses the second adhesives on the first adhesives.

23. The method for fabricating a display device of claim 22, wherein viscosity of the second adhesives that are spread or dispensed is equal to or lower than 500 cP.

24. The method for fabricating a display device of claim 19, further comprising: main-curing the first adhesives and the second adhesives after the bonding the display panel and the window through the first adhesives and the second adhesives.
